(19) United States
(12) Patent Application Publication
(10) Pub. No.: US 2018/0246638 A1
(43) Pub. Date: Aug. 30, 2018

(54) METHOD FOR OPERATING AN INPUT DEVICE, AND INPUT DEVICE

(71) Applicant: AUDI AG, Ingolstadt (DE)

(72) Inventors: Ulrich MUELLER, Ingolstadt (DE); Tobias SPIELMANNLEITNER, Koesching (DE); Manfred MITTERMEIER, Altmannstein (DE)

(73) Assignee: AUDI AG, Ingolstadt (DE)

(21) Appl. No.: 15/756,421

(22) PCT Filed: Aug. 24, 2016
(86) PCT No.: PCT/EP2016/069966

§ 371 Date: Feb. 28, 2018

(30) Foreign Application Priority Data
Nov. 20, 2015 (DE) 10 2015 015 075.8

(51) Int. Cl. G06F 3/0488; G06F 3/01

(52) U.S. Cl. CPC G06F 3/04883; G06F 3/016; G06F 3/04886

(57) ABSTRACT

With a graphical user interface is displayed on a touch-sensitive display unit, a tactilely perceptible feedback is output on the display unit by an actuator as long as a finger sweeping over the display unit in the region of the displayed graphical user interface is detected. An intensity of the tactilely perceptible feedback is predefined depending on a speed at which the finger sweeps over the display unit in the region of the displayed graphical user interface.

### CROSS REFERENCE TO RELATED APPLICATIONS

This application is the U.S. national stage of International Application No. PCT/EP2016/069966, filed Aug. 24, 2016, and claims the benefit thereof. The International Application claims the benefit of German Application No. 10 2015 015 075.8 filed on Nov. 20, 2015, both applications are incorporated by reference herein in their entirety.

### BACKGROUND

Described below are a method for operating an input device and the input device, as well as a motor vehicle having such an input device.

To support the operation of touch-sensitive display units, such as touchscreens, for example, use is often made of so-called force feedback, that is to say the outputting or bringing about of a tactilely perceptible feedback. In other words, a user acquires a haptic feedback during the operation of a touch-sensitive display unit, comparable with operation of a mechanical button. When the touch-sensitive display unit is touched or actuated, it is vibrated or slightly accelerated mechanically, such that the user feels a mechanical impulse or a haptically perceptible impulse, as a result of which the user acquires a haptic feedback.

US 2014/139450 A1 discloses a method for outputting a tactile feedback on a touch-sensitive screen. By way of example, a virtual sliding switch is displayed by the touch-sensitive screen. As soon as a user sweeps over the virtual sliding switch, a tactile feedback is output on the touch-sensitive screen. The tactile feedback is generated by an actuator, for example, which may be configured in the form of an electromagnet or piezoelement.

DE 10 2009 026 408 A1 likewise discloses a method for operating a touch-sensitive screen. A sliding controller is displayed on the touch-sensitive screen. By sweeping over the sliding controller, a user can alter an amplitude of a tactile feedback which can be output on the touch-sensitive screen.

DE 10 2011 002 835 A1 discloses a method for operating a joystick by which a touch-sensitive screen is controlled. The more pressure a user exerts on the joystick, the faster a content displayed by the touch-sensitive screen is displaced. In this case, a tactile feedback output on the joystick is output to a greater extent, the higher the actuation pressure on the joystick.

### SUMMARY

Described herein are a method for operating an input device and an input device by which a tactilely perceptible feedback can be output on the display unit in an improved manner.

In the method described herein for operating an input device, a graphical user interface is displayed by a touch-sensitive display unit and a tactilely perceptible feedback is output on the display unit by an actuator as long as a finger sweeping over the display unit in the region of the displayed graphical user interface is detected. An intensity of the tactilely perceptible feedback is predefined depending on a speed at which the finger sweeps over the display unit in the region of the displayed graphical user interface.

When the finger sweeps rapidly over the display unit in the region of the displayed graphical user interface, the outputting of the tactilely perceptible feedback might be perceived to be unpleasant if the latter is always output in the same way independently of the sweeping speed. This is because, in such a case, a multiplicity of tactilely perceptible impulses would be generated successively in the event of a fast sweeping movement over the display unit.

Therefore, the method provides for the intensity of the haptic impulses that are output, that is to say of the tactilely perceptible feedback, on the touch-sensitive display unit to be controlled depending on the speed of the finger movement over the touch-sensitive display unit. As a result, the intensity of the tactilely perceptible feedback is adapted to the speed of the sweeping movement of the finger. Even in the event of fast sweeping over the touch-sensitive display unit, it is thus possible to prevent unpleasant vibrations in the form of the tactilely perceptible feedback that is output. For this purpose, the touch-sensitive display unit itself can be configured for example to detect the touching location on the touch-sensitive display unit and the sweeping speed of the finger. The intensity of the tactilely perceptible feedback can thus be adapted depending on the touching location and the sweeping speed.

One advantageous embodiment provides for a sliding controller to be displayed as part of the graphical user interface, wherein the intensity of the tactilely perceptible feedback is predefined depending on the speed at which the finger sweeps over the display unit in the region of the displayed sliding controller. If the input device is installed in a motor vehicle, for example, the displayed sliding controller can serve for example to set the ventilation intensity of a fan of the motor vehicle. Depending on how fast a vehicle occupant sweeps over the displayed sliding controller, the intensity of the tactilely perceptible feedback is adapted and output accordingly.

The sliding controller may be displayed in the form of a plurality of elements arranged one behind another in a series, wherein the intensity of the tactilely perceptible feedback is predefined depending on the elements swept over by the finger per unit time. In the case of the fan regulation mentioned by way of example, provision can be made for the fan to be set one level higher per element swept over. For each element swept over, by way of example, a tactilely perceptible feedback can be generated on the display unit by the actuator in order that switching to the next higher fan level is made identifiable to the user in a haptically perceptible manner. In this case, the intensity of the tactilely perceptible feedback is adapted to the sweeping speed in accordance with which a user sweeps his/her finger over the elements of the displayed sliding controller that are arranged one behind another in a series.

A further advantageous embodiment provides for the intensity of the tactilely perceptible feedback to be predefined to be all the smaller, the faster the finger sweeps over the display unit in the region of the displayed graphical user interface. Thus, if a user sweeps his/her finger particularly fast over the region of the displayed graphical user interface, then the intensity of the tactilely perceptible feedback is chosen to be particularly small, and vice versa. The speed-dependent adaptation of the intensity of the tactilely perceptible feedback makes it possible to prevent the outputting of the tactilely perceptible feedback from being perceived as unpleasant particularly in the event of fast sweeping over the touch-sensitive display unit.

A further advantageous configuration provides for predefining the intensity of the tactilely perceptible feedback to involve predefining a stroke of the actuator in accordance with which the display unit is deflected for outputting the tactilely perceptible feedback. If the intensity of the tactilely perceptible feedback is predefined for example antiproportionally to the detected sweeping speed over the touch-sensitive display unit, then the stroke of the actuator is chosen to be all the smaller, the faster a user sweeps his/her finger over the touch-sensitive display unit. By varying the stroke of the actuator in accordance with which the display unit is deflected for outputting the tactilely perceptible feedback, it is possible to vary the intensity of the tactilely perceptible feedback in a particularly simple manner.

A further advantageous embodiment provides for predefining the intensity of the tactilely perceptible feedback to involve predefining an acceleration of the actuator in accordance with which the display unit is deflected for outputting the tactilely perceptible feedback. By way of example, provision can be made for the acceleration of the actuator in accordance with which the display unit is deflected for outputting the tactilely perceptible feedback to be chosen to be all the lower, the faster a user sweeps his/her finger over the touch-sensitive display unit. The force with which the tactilely perceptible feedback is effected may be smaller, the faster a user sweeps his/her finger over the touch-sensitive display unit. By varying the acceleration of the actuator in accordance with which the display unit is deflected for outputting the tactilely perceptible feedback, it is possible to vary the intensity of the tactilely perceptible feedback in a speed-dependent manner, that is to say depending on the sweeping speed of a finger over the touch-sensitive display unit, in a particularly simple way.

In a further advantageous configuration, it is provided that a first intensity for the tactilely perceptible feedback is predefined if the speed in accordance with which the finger sweeps over the display unit in the region of the displayed graphical user interface is less than a predefined speed value, and a second intensity for the tactilely perceptible feedback is predefined if the speed in accordance with which the finger sweeps over the display unit in the region of the displayed graphical user interface is at least equal in magnitude to the predefined speed value. In other words, provision can thus be made for the intensity of the tactilely perceptible feedback to be varied only in two stages. The control complexity and the detection complexity for varying the intensity of the tactilely perceptible feedback can be kept particularly simple as a result.

In accordance with an alternative advantageous embodiment, it is provided that the intensity of the tactilely perceptible feedback is predefined in accordance with a provided family of characteristic curves in which different speed ranges in accordance with which the finger sweeps over the display unit in the region of the displayed graphical user interface are assigned respective intensities for the tactilely perceptible feedback. The variation of the intensity of the tactilely perceptible feedback depending on the sweeping speed in accordance with which a user sweeps his/her finger over the touch-sensitive display unit can be varied in particularly fine stages as a result. Furthermore, provision can also be made for the values stored in the family of characteristic curves for the different speed ranges and the intensities assigned thereto for the tactilely perceptible feedback to be able to be individualized, such that a user can alter the speed-dependent adaptation of the intensity of the tactilely perceptible feedback in accordance with his/her preferences.

The input device described herein includes a touch-sensitive display unit, an actuator for outputting a tactilely perceptible feedback on a display unit, and a control unit, which is designed to drive the actuator for outputting the tactilely perceptible feedback as long as a finger sweeping over the display unit in the region of a graphical user interface displayed by the display unit is detected. In this case, the input device has a control unit designed to predefine an intensity of the tactilely perceptible feedback depending on a speed at which the finger sweeps over the display unit in the region of the displayed graphical user interface. In this case, advantageous configurations of the method should be regarded as advantageous configurations of the input device which includes the ability to carry out the described method.

A motor vehicle may include the input device or an advantageous embodiment of the input device. Furthermore, it is also possible for the input device or an advantageous embodiment of the input device to be used in a mobile terminal, in particular in a mobile communication terminal. By way of example, the input device can be installed in a tablet computer or a smartphone.

### BRIEF DESCRIPTION OF THE DRAWINGS

These and other aspects, advantages, features and details will become more evident and more readily appreciated from the following description of exemplary embodiment(s) and with reference, taken in conjunction with the drawings. The features and feature combinations mentioned above and the features and feature combinations mentioned below and/or shown solely in the drawings can be used not only in the combination respectively indicated, but also in other combinations or by themselves, without departing from the scope of the invention.

In the drawings:

FIG. 1 is a schematic block diagram of a motor vehicle with an input device having a touch-sensitive display unit, an actuator for outputting a tactilely perceptible feedback on the display unit, and also a control unit for driving the actuator; and

FIG. 2 is a schematic front view of the touch-sensitive display unit, having a graphical user interface for adjusting a ventilation intensity of an air-conditioning system of the motor vehicle which is displayed by the display unit.

### DETAILED DESCRIPTION OF THE PREFERRED EMBODIMENT

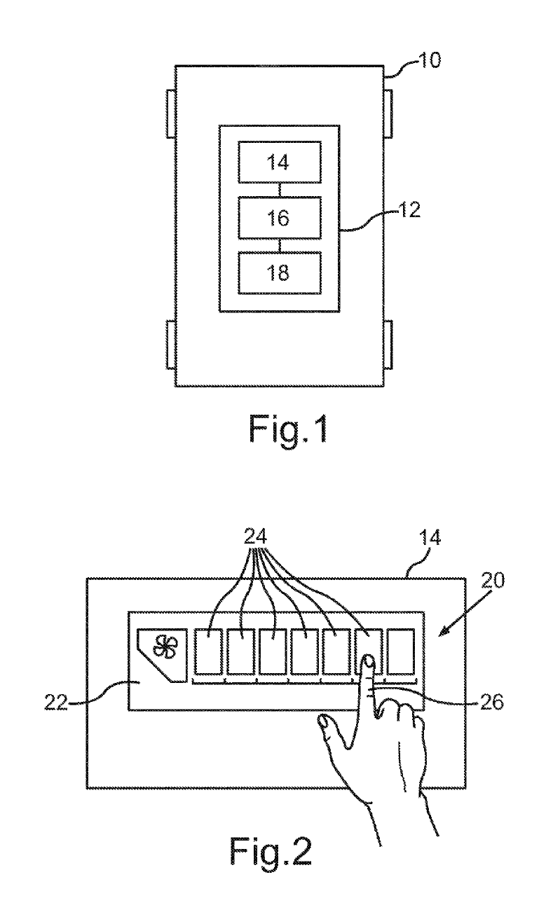

A motor vehicle 10 having an input device 12 is shown in a schematic illustration in FIG. 1. The input device 12 includes a touch-sensitive display unit 14, an actuator 16 for outputting a tactilely perceptible feedback on the display unit 14, and a control unit 18 for driving the actuator 16. The touch-sensitive display unit 14 can be a touchscreen, for example, which is installed for example in the region of a center console of the motor vehicle 10. The display unit 14 is designed to display a wide variety of graphical user interfaces, such that a vehicle occupant can control a wide variety of vehicle functions by touching and actuating the touch-sensitive display unit 14. In this case, the actuator 16 is designed to bring about tactilely perceptible feedbacks on the display unit 14 depending on detected touches or actuations of the touch-sensitive display unit 14.

FIG. 2 schematically illustrates the touch-sensitive display unit 14, wherein a graphical user interface 20 for adjusting the ventilation intensity of an air-conditioning system of the motor vehicle 10 is currently being displayed by the display unit 14. As can be discerned, a virtual sliding controller 22 is displayed as part of the graphical user interface 20, the sliding controller being displayed in the form of a plurality of elements 24 arranged one behind another in a series. If a vehicle occupant sweeps his/her finger 26 toward the left in the region of the display unit 14 in which the elements 24 of the sliding controller 22 are displayed, then a ventilation intensity or fan intensity of the air-conditioning system is correspondingly reduced. If the user sweeps his/her finger 26 from left to right, then a ventilation intensity of the air-conditioning system is increased. In order that the vehicle occupant acquires a haptically perceptible feedback upon sweeping over the graphical user interface 20, the control unit 18 drives the actuator 16 in such a way that a tactilely perceptible feedback is output on the display unit 14 on every occasion as soon as the vehicle occupant sweeps his/her finger 26 over one of the elements 24 of the sliding controller 22. In this context, provision can additionally also be made for an acoustic feedback to be output, for example via the loudspeakers of the motor vehicle 10, specifically whenever the vehicle occupant sweeps his/her finger 26 over one of the elements 24.

In the event of fast sweeping over the elements 24, the tactilely perceptible feedbacks brought about by the actuator on the display unit 14 do not have an unpleasant effect, because the intensity of the tactilely perceptible feedback is predefined by the control unit 18 depending on a speed at which the finger 26 sweeps over the display unit 14 in the region of the sliding controller 22. In this case, the touch-sensitive display unit 14 may itself be designed to detect respective touching positions at which the latter are touched by the finger 26 and to forward this information to the control unit 18. On the basis of this information, the control unit 18 can determine the speed at which the vehicle occupant is currently sweeping his/her finger 26 over the touch-sensitive display unit 14.

Furthermore, the intensity of the tactilely perceptible feedback can be predefined depending on the elements 24 swept over by the finger 26 per unit time. In this case, the control unit 18 may predefine the intensity of the tactilely perceptible feedback to be smaller, the faster the finger 26 sweeps over the display unit 14 in the region of the sliding controller 22. In other words, if the vehicle occupant sweeps his/her finger 26 particularly fast over the elements 24 of the sliding controller 22, then respective tactilely perceptible feedbacks are effected by the actuator 16 less intensively than if the vehicle occupant swept his/her finger 26 relatively slowly over the elements 24.

The intensity of the tactilely perceptible feedbacks that can be brought about by the actuator 16 on the touch-sensitive display unit 14 should be understood to mean in particular a stroke of the actuator 16 in accordance with which the display unit 14 is deflected for outputting the tactilely perceptible feedbacks. Moreover, the intensity of the tactilely perceptible feedback should also be understood to mean an acceleration of the actuator 16 in accordance with which the display unit 14 can be deflected for outputting the tactilely perceptible feedbacks. In other words, if the vehicle occupant sweeps his/her finger 26 particularly fast over the sliding controller 22, then the touch-sensitive display unit 14 is deflected in the direction of the finger 26 to a lesser extent than if the vehicle occupant swept his/her finger 26 more slowly over the sliding controller 22. The same applies to the acceleration with which the actuator 16 deflects the display unit 14 in the direction of the finger 26.

In the simplest case, the speed-dependent variation of the intensity of the tactilely perceptible feedback can be effected in two stages. If the speed in accordance with which the finger 26 sweeps over the display unit 14 in the region of the displayed graphical user interface 20 is less than a predefined speed value, then a first intensity for the tactilely perceptible feedback is predefined. If the speed in accordance with which the finger 26 sweeps over the display unit 14 in the region of the displayed graphical user interface 20 is at least equal in magnitude to the predefined speed value, a second intensity for the tactilely perceptible feedback is predefined. The second intensity in this case may be greater than the first intensity.

Instead of the only two-stage variation of the intensity of the tactilely perceptible feedback, however, provision can also be made of a variation of the intensity that has more than two stages. By way of example, the intensity of the tactilely perceptible feedback can be predefined in accordance with a provided family of characteristic curves in which different speed ranges in accordance with which the finger 26 sweeps over the display unit 14 in the region of the displayed graphical user interface 20 are assigned respective intensities for the tactilely perceptible feedback. The more speed ranges and intensities assigned thereto are stored in the family of characteristic curves, the finer the stages with which the speed-dependent variation of the intensity of the tactilely perceptible feedback can be effected.

In this case, the speed-dependent variation of the intensity of the tactilely perceptible feedback is not just restricted to the actuation of the displayed sliding controller 22. The variation of the intensity of the tactilely perceptible feedback depending on the sweeping speed can be applied to all sliding or swiping movements over the touch-sensitive display unit 14. Depending on the contents of the graphical user interface 20 that are displayed by the display unit 14 and depending on the sweeping speed over the touch-sensitive display unit 14, it is thus possible very generally to perform a variation of the intensity of the tactilely perceptible feedback which is brought about on the display unit 14 by the actuator 16.

In this case, the input device 12 and the above-described mode of operation of the input device 12 is not just restricted to use in motor vehicles 10. The input device 12 can for example also be part of a smartphone or of a tablet computer.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-12. (canceled)

13. A method for operating an input device, comprising:
displaying a graphical user interface, including a sliding controller, in a region of a touch-sensitive display unit; and
outputting a tactilely perceptible feedback on the touch-sensitive display unit by an actuator as long as a finger sweeping over the touch-sensitive display unit in the region of the graphical user interface is detected, an intensity of the tactilely perceptible feedback being predefined depending on a speed at which the finger sweeps over the touch-sensitive display unit in the region of the graphical user interface where the sliding controller is displayed, the intensity of the tactilely perceptible feedback being predefined to be smaller as the finger sweeps faster over the touch-sensitive display unit in the region of the graphical user interface.

14. The method as claimed in claim 13,
wherein said displaying displays the sliding controller as a plurality of elements arranged one beside another in a series, and
wherein the intensity of the tactilely perceptible feedback is predefined depending on the elements swept over by the finger per unit time.

15. The method as claimed in claim 13, wherein the intensity of the tactilely perceptible feedback is predefined by predefining a stroke of the actuator which causes the touch-sensitive display unit to be deflected in said outputting of the tactilely perceptible feedback.

16. The method as claimed in claim 13, wherein the intensity of the tactilely perceptible feedback is predefined by predefining an acceleration of the actuator which causes the touch-sensitive display unit to be deflected in said outputting of the tactilely perceptible feedback.

17. The method as claimed in claim 13, wherein a first intensity of the tactilely perceptible feedback is predefined for when the speed with which the finger sweeps over the touch-sensitive display unit in the region of the graphical user interface is less than a predefined speed value, and a second intensity of the tactilely perceptible feedback is predefined for when the speed with which the finger sweeps over the touch-sensitive display unit in the region of the displayed graphical user interface is at least equal in magnitude to the predefined speed value.

18. The method as claimed in claim 13, wherein the intensity of the tactilely perceptible feedback is predefined in accordance with a family of characteristic curves in which different speed ranges of the finger over the touch-sensitive display unit in the region of the graphical user interface are assigned respective intensities of the tactilely perceptible feedback.

19. An input device, comprising:
a touch-sensitive display unit having a region displaying a graphical user interface with a sliding controller;
an actuator configured to output a tactilely perceptible feedback on the touch-sensitive display unit; and
a control unit configured to drive the actuator to output the tactilely perceptible feedback, as long as a finger sweeping over the touch-sensitive display unit in the region of the graphical user interface displayed by said touch-sensitive display unit is detected, with an intensity of the tactilely perceptible feedback depending on a speed at which the finger sweeps over the touch-sensitive display unit in the region of the graphical user interface where the sliding controller is displayed, the intensity of the tactilely perceptible feedback being predefined to be smaller as the finger sweeps faster over the touch-sensitive display unit in the region of the graphical user interface.

20. The input device as claimed in claim 19,
wherein said touch-sensitive display unit displays the sliding controller as a plurality of elements arranged one beside another in a series, and
wherein said control unit is configured to predefine the intensity of the tactilely perceptible feedback depending on the elements swept over by the finger per unit time.

21. The input device as claimed in claim 19, wherein said control unit is configured to predefine the intensity of the tactilely perceptible feedback by predefining a stroke of said actuator which causes said touch-sensitive display unit to be deflected to output the tactilely perceptible feedback.

22. The input device as claimed in claim 19, wherein said control unit is configured to predefine the intensity of the tactilely perceptible feedback by predefining an acceleration of said actuator which causes said touch-sensitive display unit to be deflected in the tactilely perceptible feedback.

23. The input device as claimed in claim 19, wherein said control unit is configured to predefine the intensity of the tactilely perceptible feedback with a first intensity when the speed with which the finger sweeps over the display unit in the region of the graphical user interface is less than a predefined speed value, and a second intensity when the speed with which the finger sweeps over the display unit in the region of the displayed graphical user interface is at least equal in magnitude to the predefined speed value.

24. The input device as claimed in claim 19, wherein said control unit is configured to predefine the intensity of the tactilely perceptible feedback in accordance with a family of characteristic curves in which different speed ranges of the finger over said touch-sensitive display unit in the region of the graphical user interface are assigned respective intensities of the tactilely perceptible feedback.

25. An apparatus, comprising;
an enclosure; and
an input device, including
a touch-sensitive display unit having a region displaying a graphical user interface with a sliding controller;
an actuator configured to output a tactilely perceptible feedback on the touch-sensitive display unit; and
a control unit configured to drive the actuator to output the tactilely perceptible feedback, as long as a finger sweeping over the touch-sensitive display unit in the region of the graphical user interface displayed by the touch-sensitive display unit is detected, with an intensity of the tactilely perceptible feedback depending on a speed at which the finger sweeps over the touch-sensitive display unit in the region of the graphical user interface where the sliding controller is displayed, the intensity of the tactilely perceptible feedback being predefined to be smaller as the finger sweeps faster over the touch-sensitive display unit in the region of the graphical user interface.

26. The apparatus as claimed in claim 25, wherein the enclosure is a motor vehicle.

27. The apparatus as claimed in claim 26,
wherein the touch-sensitive display unit displays the sliding controller as a plurality of elements arranged one beside another in a series, and
wherein the control unit is configured to predefine the intensity of the tactilely perceptible feedback depending on the elements swept over by the finger per unit time.

28. The apparatus as claimed in claim 26, wherein the control unit is configured to predefine the intensity of the tactilely perceptible feedback by predefining an acceleration of said actuator which causes the touch-sensitive display unit to be deflected in outputting the tactilely perceptible feedback.

29. The apparatus as claimed in claim 26, wherein the control unit is configured to predefine the intensity of the tactilely perceptible feedback with a first intensity when the speed with which the finger sweeps over the display unit in the region of the graphical user interface is less than a predefined speed value, and a second intensity when the speed with which the finger sweeps over the display unit in the region of the displayed graphical user interface is at least equal in magnitude to the predefined speed value.

30. The apparatus as claimed in claim 26, wherein the control unit is configured to predefine the intensity of the tactilely perceptible feedback in accordance with a family of characteristic curves in which different speed ranges of the finger over the touch-sensitive display unit in the region of the graphical user interface are assigned respective intensities of the tactilely perceptible feedback.

31. The apparatus as claimed in claim 25, wherein the enclosure is a smartphone.

32. The apparatus as claimed in claim 25, wherein the enclosure is a tablet computer.
